(19) United States
(12) Patent Application Publication
(10) Pub. No.: US 2004/0073528 A1
(43) Pub. Date: Apr. 15, 2004

(54) Continuous variable prediction lift chart systems and methods

(76) Inventors: Zhaohui Tang, Bellevue, WA (US); David E. Heckerman, Bellevue, WA (US); David M. Chickering, Bellevue, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/270,939

(22) Filed: Oct. 15, 2002

(51) Int. Cl. G06E 1/00

(52) U.S. Cl. 706/21

(57) ABSTRACT

The present invention relates to a system and methodology to generate and provide a lift chart to determine accuracy of one or more models that predict continuous variable data. Systems and processes are provided that process continuous variable prediction data in accordance with various analytical techniques. The processed data is then formatted for display, wherein model performance can then be determined by comparisons between models and/or by comparisons to idealized model performance. In one aspect, a system is provided that generates a continuous variable prediction lift chart. The system includes an analyzer that receives data from one or more models and a continuous variable test data set, wherein the formatter then generates a lift chart based on the analyzed models and the continuous variable test data set.

### TECHNICAL FIELD

The present invention relates generally to computer systems, and more particularly to a system and method to facilitate analysis and display of continuous variable prediction data derived in part from one or more models that generate such data.

### BACKGROUND OF THE INVENTION

Data mining relates to the exploration and analysis of large quantities of data in order to discover correlations, patterns, and/or trends in the data. Data mining may also be employed to create models that can predict future data or classify existing data. For example, a business may amass a large collection of information about its customers. This information may include purchasing information and any other information available to the business about the customer. Thus, predictions of a model associated with customer data may be utilized, for example, to control customer attrition, to perform credit-risk management, to detect fraud, or to make decisions on marketing.

To create and test a data mining model, available data may be divided into two parts. One part, the training data set, may be used to create models. The rest of the data, the testing data set, may be employed to test the model, and thereby determine the accuracy of the model in making predictions. Furthermore, data within a respective data set can be grouped into cases. For example, with customer data, each case corresponds to a different customer. Data in the case describes or is otherwise associated with that customer. One type of data that may be associated with a case (for example, with a given customer) is a categorical variable. A categorical variable categorizes the case into one of several pre-defined states. For example, one such variable may correspond to the educational level of the customer. There are various values for this variable. The possible values are known as states. For instance, the states of the educational level variable may be “high school degree,” “bachelor's degree,” or “graduate degree” and may correspond to the highest degree earned by the customer.

As mentioned previously, available data may be partitioned into two groups—a training data set and a testing data set. Often 70% of the data is utilized for training and 30% for testing. A model may be trained on the training data set, which includes this information. After a model is trained, it may be run on the testing data set for evaluation. During such testing, the model may be given all of the data except the educational level data for this example, and asked to predict a probability that the educational level variable for that customer is “bachelor's degree”.

After running the model on the testing data set for predicted results, the results are compared to the actual testing data to see whether the model correctly predicted a high probability of the “bachelor's degree” state for cases that actually have “bachelor's degree” as the state of the educational level variable. One method of displaying the success of a model graphically is by means of a lift chart, also known as a cumulative gains chart. To create a lift chart, the cases from the testing data set are sorted according to the probability assigned by the model that the variable (e.g., educational level) has the state (e.g., bachelor's degree) that was tested, from highest probability to lowest probability. Once this is achieved, a lift chart can be created from data points (X, Y) showing for each point what number Y of the total number of true positives (those cases where the variable does have the state being tested for) are included in the X% of the testing data set cases with the highest probability for that state, as assigned by the model.

As can be appreciated, data mining models can be constructed to predict various different variable types having various states associated therewith. One such variable type is a discrete variable which is a variable that has a finite number of distinct values. For example, responses to a five-point rating scale can only take on the values 1, 2, 3, 4, and 5. The variable cannot have the value 1.7, for example. On the other hand, a variable such as a person's height or weight can take on any value. A continuous variable is one for which, within the limits the variable ranges, an infinite number of values are possible. For example, the variable “Time to solve a given math problem” is continuous since it could take 2 minutes, 2.13 minutes and so forth to finish the problem. In contrast, the variable “Number of correct answers on a 100 point multiple-choice test” is not a continuous variable since it is not possible to get 54.12 problems correct.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates to a system and methodology to facilitate analysis of one or more models that are employed to predict continuous variable data. A continuous variable lift chart is provided, wherein one or more models that predict continuous variable data are analyzed in accordance with various automated and/or manual systems and processes. The analyzed data is then presented or formatted in the form of a lift chart in order that model performance may be determined. In one aspect, model predictions can be organized into various categories or discretized ranges of prediction data that have been automatically and/or manually determined for a continuous variable. Such variables can include substantially any type of continuous data that is defined over a known distribution of the data (e.g., age, income, weight, measurements, statistics, formulaic output, floating point values, and so forth). When the data categories or ranges have been determined, the lift chart plots the predictive accuracy or performance of the analyzed model or models in view of the determined categories or ranges (e.g., plot continuous data according to likelihood model predicts the data within a determined range versus other non-selected ranges, or according to how well predictions relate to a plurality of ranges). Various controls can be employed to generate automated and/or selected display outputs on the lift chart that facilitate analysis and/or visualization of model capabilities (e.g., graphically view one model's performance in view of other models or idealized model). In another aspect, continuous variable model predictions are compared to actual observations or values of continuous data in a non-discretized manner (as opposed to a discretized range for such data) and plotted in accordance with a predetermined interval that defines whether or not such predictions fall within the predetermined interval or tolerance of actual observations or values.

According to one aspect of the present invention, continuous variable prediction data can be discretized into one or more ranges in accordance with automated determinations and/or manual specifications of such ranges. A continuous variable lift chart can then be constructed by plotting whether or not one or more models predict continuous data that falls into or is within a selected discretized range in view of other non-selected ranges. In another aspect, multiple ranges are considered and analyzed for a continuous variable, wherein models are analyzed in accordance with a capability to all ranges (or a specified/determined subset(s) of ranges). Model performance is then plotted according to whether or not, or how well continuous variable predictions forecast the ranges and according to the likelihood such predictions are within the various ranges. In yet another aspect, continuous variable predictions are made and compared with actual observations for such predictions in a non-discretized manner. A predetermined interval is defined, wherein if a continuous variable prediction falls within the predetermined interval, then plotted model performance depicts whether or not (or how well) various predictions are within the predetermined interval or tolerance as defined/determined for such predictions.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a schematic block diagram illustrating generation of a continuous variable lift chart in accordance with an aspect of the present invention.

FIG. 2 is a diagram illustrating a continuous variable analyzer in accordance with an aspect of the present invention.

FIG. 3 is a diagram illustrating a continuous variable formatter in accordance with an aspect of the present invention.

FIG. 4 is a diagram illustrating a single range variable lift chart in accordance with an aspect of the present invention.

FIG. 5 is a diagram illustrating multi-range continuous variable lift chart in accordance with an aspect of the present invention.

FIG. 6 is a diagram illustrating a non-discretized continuous variable lift chart in accordance with an aspect of the present invention.

FIG. 7 is a diagram illustrating a discretized process for creating a continuous variable lift chart in accordance with an aspect of the present invention.

FIG. 8 is a diagram illustrating a non-discretized process for creating a continuous variable lift chart in accordance with an aspect of the present invention.

FIG. 9 is a schematic block diagram illustrating a suitable operating environment in accordance with an aspect of the present invention.

### DETAILED DESCRIPTION OF THE INVENTION

The present invention relates to a system and methodology to generate and provide a lift chart to determine accuracy of one or more models that predict continuous variable data. Discretized and Non-Discretized systems and processes are provided that process continuous variable prediction data in accordance with various analytical techniques. The processed data is then formatted for display, wherein model performance can then be determined by comparisons between models and/or by comparisons to idealized model performance. In one aspect, a system is provided that generates a continuous variable prediction lift chart. The system includes an analyzer that receives data from one or more models and a continuous variable test data set, wherein the formatter then generates a lift chart based on the analyzed models and the continuous variable test data set. In another aspect, a data mining tool is provided that verifies the accuracy of a mining model prediction for continuous variable data. Continuous variable data is dynamic data that changes over time such as age or salary, for example. Model prediction is typically visualized in graph form such as in a lift chart, wherein mining models can generate modeling results that could be expected from a query or set of queries in one aspect of the present invention (e.g., from a set of SQL queries).

It noted that as used in this application, terms such as “component,” “analyzer,” “formatter,” and the like are intended to refer to a computer-related entity, either hardware, a combination of hardware and software, software, or software in execution. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers. In another example, an analyzer can be a process executable on a computer to process continuous variables in accordance with discretized and non-discretized determinations (e.g., mathematical/statistical processing). Similarly, a formatter can output continuous variable data as a display process to provide a continuous variable lift chart in accordance with the present invention. Such output can include computer displays and printers, for example, and include remote formatting such as displaying continuous variable prediction results in accordance with a network, data packet, web browser, web page, web service, and so forth.

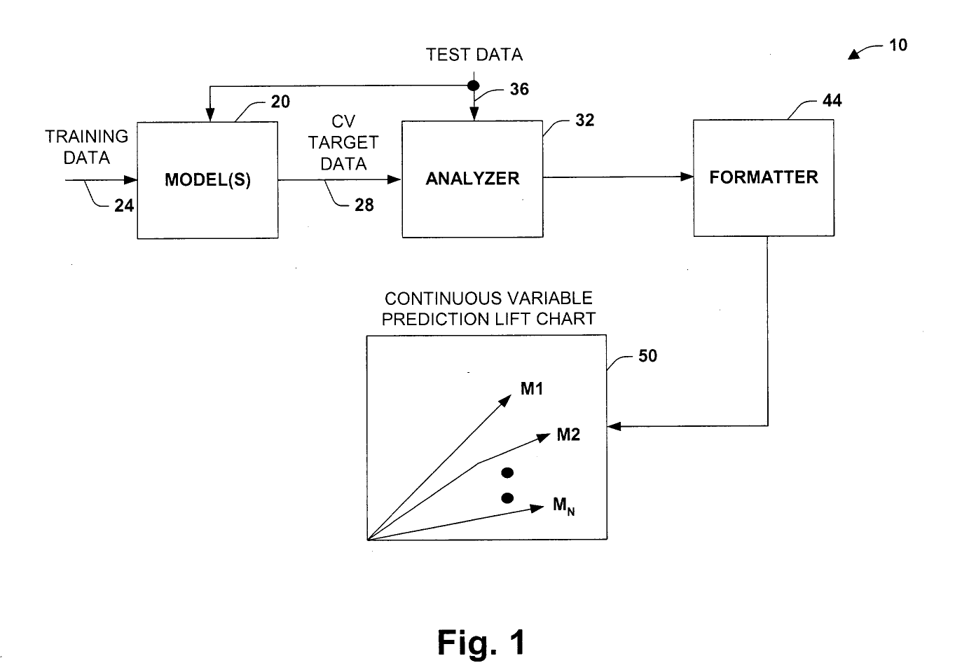

Referring initially to FIG. 1, a system 10 illustrates generation of a continuous variable lift chart in accordance with an aspect of the present invention. One or more models 20 (e.g., prediction models, data mining models) receive data from a training data set 24 and predict continuous variable (CV) target data 28. The CV target data 28 can include substantially any type of continuous variable prediction given the training data set 24. As one example, given known data associated with a person (e.g., education level, zip code, web sites visited, shopping selections, and so forth) predictions can be made regarding the person's income or age which are possible examples of continuous variables. It is to be appreciated the present invention is no so limited however, in that the models 20 can predict any type of continuous variable. For example, a mathematical model 20 may observe analysis data from the training data set 24 relating to an Engineering problem and produce a continuous variable prediction at 28 relating to one or more potential outcomes (e.g., oscillatory output prediction based upon a differential equation analysis).

After model training, the CV target data 28 is provided to an analyzer 32 that processes the CV target data in various forms (e.g., statistical, mathematical, user-defined) which are described in more detail below. In one aspect, the analyzer 32 categorizes the CV target data 28 into various determined ranges (e.g., automatically determined, user-specified), wherein a test data set 36 is employed to determine the accuracy of the CV target data in view of the determined ranges (e.g., analyze whether or not CV target data falls within a determined range or ranges as determined, defined and/or specified for the model). It is noted that the test data set 36 can be analyzed and/or collected from a subset of the training data set 24. In another aspect of the present invention, the analyzer 32 measures the accuracy of given predictions based upon a determined interval for the prediction (e.g., is the prediction within an automatically determined or user-specified interval for the prediction). Generally, the models 20 make various predictions given a distribution of a continuous variable (e.g., how well does model predict continuous variables below a determined threshold, predictions within a defined range, predictions above a defined range).

After the predictions have been made by the models 20, the analyzer 32 outputs prediction data and comparison data to a formatter 44. The comparison data which can be statistical in nature and/or can include actual values of continuous variable data, is employed by the formatter 44 to generate a continuous variable lift chart 50, wherein performance of one or more models M₁-M_{N} are displayed, N being an integer (e.g., display performance of one model verses another model or models, performance versus idealized modals). Thus, the continuous variable lift chart 50 measures and displays how well the models predict continuous variable data given the test data set 36. Model performance can be displayed on the lift chart 50 in linear and non-linear formats and in accordance with various colors, sounds, shapes, dimensions, axis identifiers, line formats, text descriptions/formats, fonts, and/or in accordance with other display/performance data.

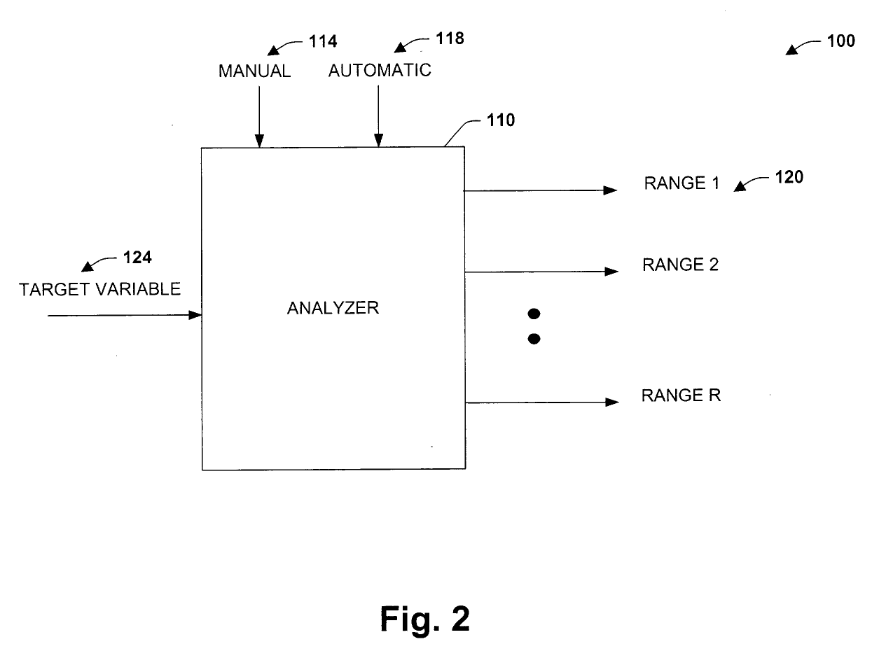

Turning now to FIG. 2, a discrete analysis system 100 is illustrated in accordance with an aspect of the present invention. An analyzer at 110 can be adapted to receive manual inputs 114 and/or automatic inputs 118 that instruct the analyzer to produce one or more ranges illustrated at 120 which are employed to determine or measure accuracy of a continuous variable model. In one aspect, the analyzer 110 discretizes a target variable 124 into a finite number of ranges 120 and is directed by a user via the manual inputs 114. For example, the user may be interested in how well a mining model predicts that a person has an income greater than $X per year, X being a continuous variable. As noted above, substantially any type or class of continuous variable can be similarly analyzed. Alternatively, the discretization can be performed automatically via automatic inputs 118. In this case, a marginal or unconditional distribution for the continuous variable is automatically determined by the analyzer 110 and the range 120 is discretized employing k-tiling or some function of the mean and standard deviation, for example. It is to be appreciated that substantially any statistical and/or mathematical technique can be utilized for determining suitable ranges 120. As one possible example of range determinations, an automated algorithm within the analyzer 110 can create three ranges of (1) less than one standard deviation (s.d.) below the mean, (2) between −1 and 1 s.d. of the mean, and (3) greater than one s.d. above the mean—although various other ranges and/or classifications can be similarly determined.

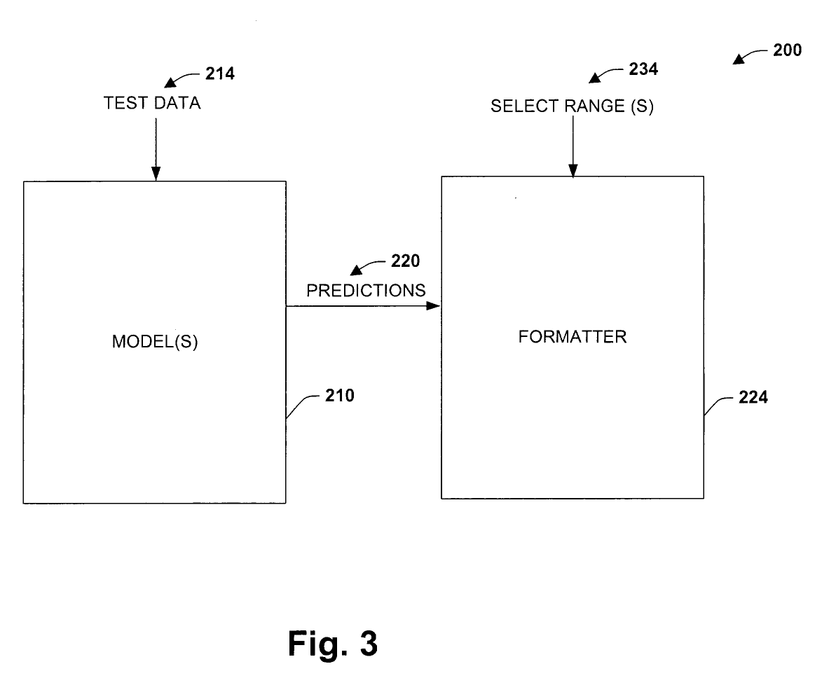

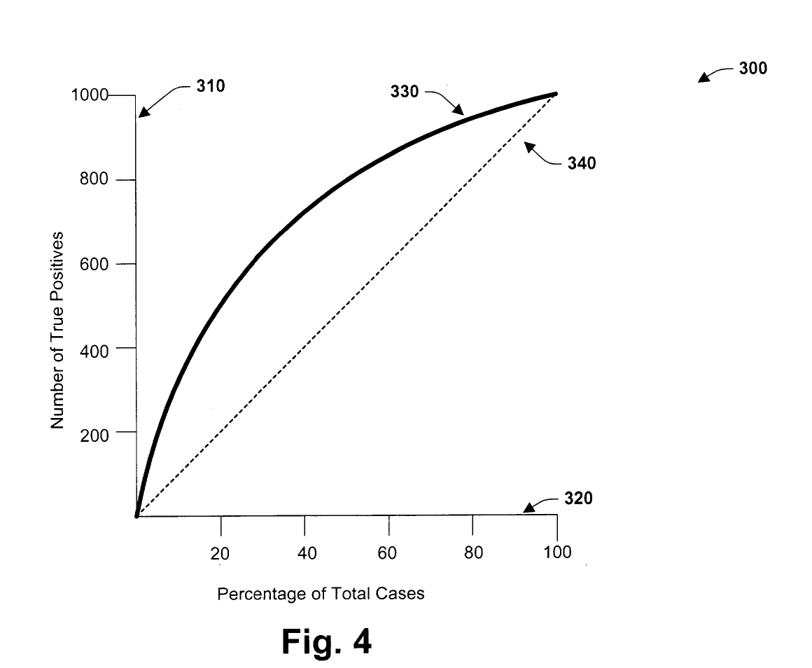

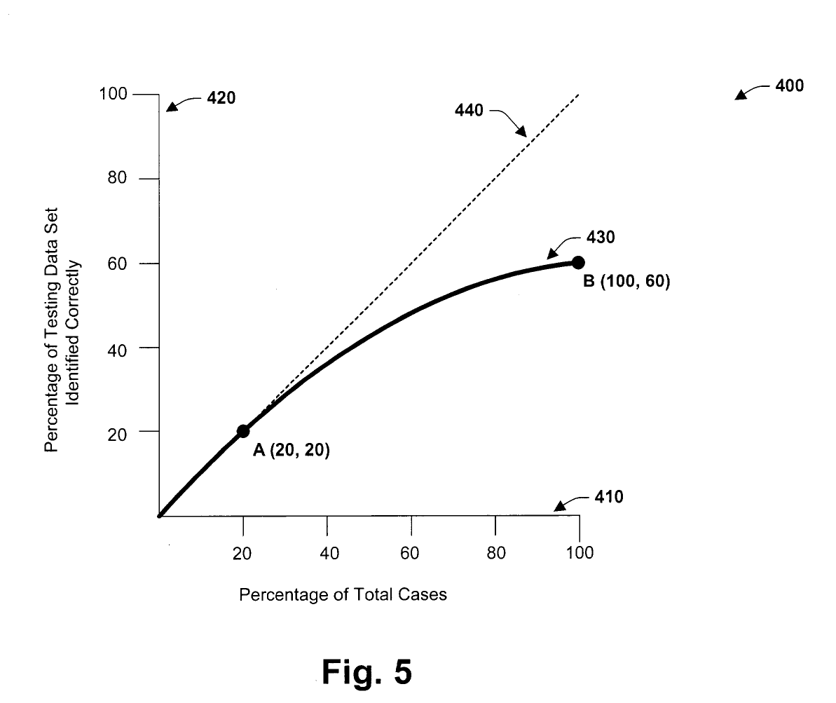

Referring now to FIG. 3, a formatting system 200 is illustrated in accordance with an aspect of the present invention. One or more models 210 analyze or process test data at 214 and generate one or more continuous variable predictions 220. The continuous variable predictions 220 are provided to a formatter 224 which drives a display output 230 in order to build a continuous variable lift chart (not shown). In one aspect of the present invention, the predictions 220 are analyzed in accordance with a selected range of interest at 234. Thus, if the predictions 220 were based on income for example, and the selected income range were incomes below $30,000, the formatter 224 would build a lift chart via the display output 230 depicting how well the models 210 predicted incomes below the selected range of $30,000 in this example. This type of chart is illustrated below in FIG. 4. In another aspect of the present invention, a plurality of ranges may be selected at 234 for analysis. For example, multiple ranges may be selected such as incomes below $25,000, incomes between $30,000 and $50,000, incomes between $54,000 and $70,000 and incomes greater than $75,000, wherein the formatter 224 would build a lift chart depicting how well various models 210 made predictions in accordance with the plurality or subset of ranges selected at 234. A multiple range chart is illustrated below in reference to FIG. 5.

When the target variable has been discretized into ranges as described above with reference to FIG. 2, various processes can be utilized to automatically build a lift chart. Whether or not the discretization was user-based, the user may still desire to select the range of interest at 234. For example, if the automated algorithm described above is utilized to discretize the target variable, the user may decide they are interested in how well the algorithm predicts “normal” and thus will select a middle range (2) from the example above. Alternatively, the range of interest can be selected automatically at 234. For example, the automated algorithm can select the range of highest values as the range of interest (or employ other criteria) at 234.

FIG. 4 illustrates a single range continuous variable lift chart 300 in accordance with an aspect of the present invention. As illustrated in FIG. 4, the continuous variable lift chart 300 depicts that there are 1000 total true positives in the testing set, although other testing amounts are possible. This is not necessarily the number of cases in the testing data set. Some cases may have a different state or range for the variable than the one for which the test is being conducted. The number of true positives in the testing data set is the highest number shown on a Y axis 310. An X axis 320 correlates with the percentage of cases with the highest probabilities or accuracy as compared to a selected range. A lift line 330 depicts the success of the model. For example, it can be observed that lift line 330 includes a point with (X, Y) coordinates are approximately (40, 700). This indicates that, in the 40% of the cases selected by the model as the most probable cases having the tested-for state of the variable or range, approximately 700 of the cases that are truly positive for the state of the variable are included. This is equivalent to getting 70% of the actual cases with the desired state in only 40% of the cases for which the test is conducted.

A model that randomly assigns probabilities a continuous variable falls in a selected range would be likely to have a chart close to the random lift line 340. In the top 10% of cases, such a model would find 10% of the true positives, for example. Note that the X axis 320 may also be expressed in the number of high probability cases, and the Y axis 310 in percentages. A perfect or idealized model may also be considered. In a situation where there are N% true positives among the entire testing data set, the lift line would stretch straight from the origin to the point (N, Y_{MAX}) (where Y_{MAX} is the maximum Y value). This is because all of the true positives would be identified before any false positives are identified. The lift line for the perfect model would then continue horizontally from that point to the right.

FIG. 5 illustrates a multi-range continuous variable lift chart in accordance with the present invention. In order to calculate and display an evaluation of the success of a model in predicting a multi-range or discretized continuous variable, one aspect of the present invention compares the predictions made on a testing set of data to the actual state of the continuous variable, known for all cases in the testing set. For respective cases, the model provides the range with the highest probability and that associated probability, for the given variable. For example, consider the data set where the cases are customers, continuous variable is income, and the ranges are “Range 1,” “Range 2,” and “Range 3.” The request to the model will be to provide the most probable range for the continuous variable (e.g., income level, age range), and the probability that the range is correct.

Thus, information, for the respective cases, about the predicted range of the continuous variable and the associated probability can be gathered. Table 1, below, illustrates an abbreviated version of a table with this information. In this table, M customer cases included in the training data, M being an integer.

TABLE 1
Customer Cases, Predicted Income, and Associated Probability

| | Predicted Range of | |
|---|---|---|
| Customer | Continuous Variable | Probability |
| 1 | Range 2 | .500 |
| 2 | Range 3 | .920 |
| 3 | Range 2 | .745 |
| 4 | Range 1 | .770 |
| 5 | Range 1 | .460 |
| 6 | Range 2 | |
| . . . | . . . | . . . |
| M | Range 3 | .550 |

When this table has been completed, it can be sorted by probability, and the information such as the one in Table 2 below is created.

TABLE 2
Customer Cases, Predicted Income, and Associated Probability

| | Predicted Range of | |
|---|---|---|
| Customer | Continuous Variable | Probability |
| 225 | Range 3 | .940 |
| 871 | Range 3 | .935 |
| 125 | Range 2 | .931 |
| 403 | Range 1 | .930 |
| 677 | Range 2 | .930 |
| 2 | Range 3 | .920 |
| . . . | . . . | . . . |
| M | Range 2 | .340 |

With this information, it is possible to examine cases by the level of certainty of the model. An automated component can determine, for some percentage X, what cases are in the top X% of the training data set cases ranked by the associated probability the model has assigned. And, having determined what those cases are, the automated component can determine, by consulting the actual value of the continuous variable for the cases in the training data set, what percentage Y of the total training data set was predicted correctly by the model. Graphing these X and Y values yields a display of the accuracy of the model on multi-range prediction over all ranges or states of a continuous variable.

FIG. 5 depicts such a multi-state prediction evaluation display 400. An X axis 410 corresponds to the percentage of total cases being considered. These cases are the cases to which the model has assigned the highest probability of correctness of the model's selected range. A Y axis 420 corresponds to the percentage of correct identifications of the testing data set contained within the cases being examined. It is noted that multi-range prediction evaluation line 430 is an exemplary evaluation line. This line represents at point A that for the 20% of the testing data set for which the model was the most certain, the model had perfect accuracy, with 20% of the testing data set being identified correctly within that first 20% of the model's predictions. However, the model's accuracy decreases as the associated probability of the guesses decreases, and point B represents that when the entire set of predictions is considered (where X=100) the model identifies the correct state for approximately only 60% of the cases in the testing data set (Y=60).

The evaluation display 400 also includes an ideal continuous variable prediction evaluation line 440. This line indicates that a perfect model would identify 20% of the testing data set correctly in the top 20% most certain predictions, 50% in the top 50%, and 100% in the top 100%. The worst-case multi-state prediction evaluation line would never get any of the state predictions correct, and it would lie overlapping the X axis. It is noted that a model is possible that has a constant rate of success, regardless of the associated probability the model assigns to correctness of the range it has selected for the continuous variable. It is, of course, also possible that a model correctly performs better on cases to which it assigns a lower associated probability. All of these situations can be represented with continuous variable prediction evaluation lines according to the present invention.

Furthermore, more than one prediction evaluation line may be displayed on a single display. This is useful, for example, in order to compare the accuracy of different models, or, in cases where there are multiple testing data sets with different characteristics, to compare the accuracy of a single model on the different testing data sets. Additionally, the display may be customized to user specifications. If a user desired to observe the accuracy of the model over a specific range of the testing set—for example, if the user desired to observe the accuracy of the model on the cases for which the associated probability of correctness was among the top half of the sorted probabilities, a section of the chart may be presented. Additionally, the relative scale of the axes could be modified. The axes could be changed to display number of cases rather than percentage. The graph could also be modified to display the difference between two models in the Y value rather than displaying each of the two models.

The prediction evaluation line 430 may be produced using approximations. For example, where there are 10,000 cases in the testing data set, it may be that the line may be produced by examining the top one hundred cases (by associated probability), then the top two hundred cases, then the top three hundred cases, and so forth, instead of evaluating the accuracy with the top case, the top two cases, the top three cases, and so forth. In this manner, computational time may be saved for a small cost in accuracy. Not all points (X, Y) on the line 430 must be exact, and the line may be produced via algorithms for creating a representative line from data points. In place of lines, data points may be displayed. Equivalent graphs may be produced by changing the scale of the axes, or by changing the position of the axes.

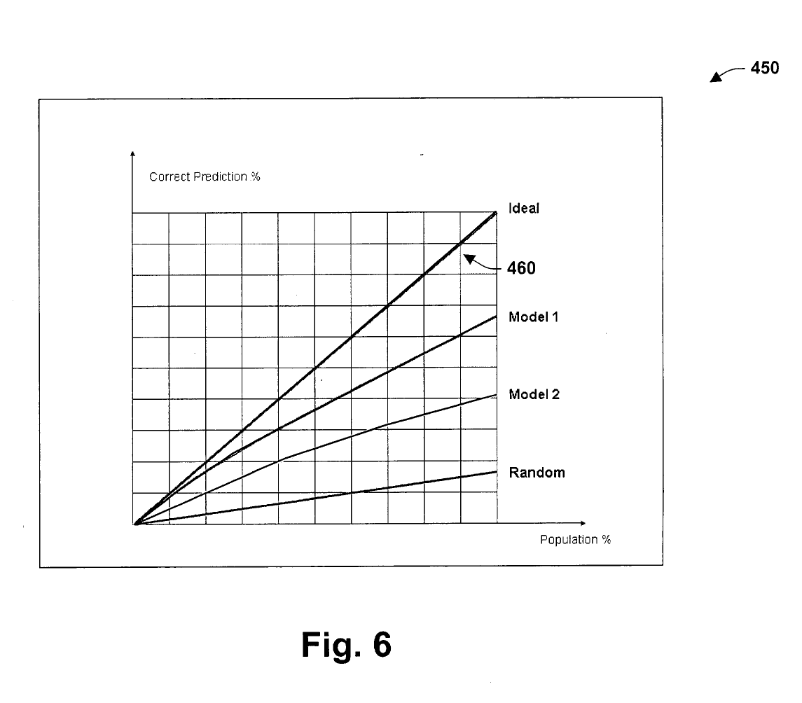

FIG. 6 illustrates a non-discretized continuous variable lift chart 450 in accordance with an aspect of the present invention. In this aspect of the invention, the lift chart 450 measures how close actual observations are to mean predictions and processes continuous variable target data without pre-discretization into ranges as described above. Cases can be ordered by a predicted standard deviation, wherein those cases with the smallest standard deviations are arranged before those having larger standard deviations—although other orderings are possible. The percentage of cases that fall within a fixed interval of the predicted mean is plotted versus the percentage of (ordered) cases considered. In accordance with the fixed interval, a parameter such as a tolerance range can be considered. This parameter is the interval within which a prediction is considered to be correct. The horizontal axis of the lift chart 450 can then be sorted by a mean of a respective prediction. A curve 460 for an “ideal” algorithm—one for which truth falls close to the mean—is illustrated in the lift chart 450. A fixed interval can be selected by a user or determined automatically (e.g., +/−s.d. from the mean in the marginal distribution).

To illustrate some exemplary models, predictions, and measurement intervals, consider two models—Model A and Model B that predict personal income.

| Continuous Variable Target | Model A | Model B |
|---|---|---|
| 30,000 | 40,000 +/− 100 | 30,000 +/− 50 |
| 45,000 | 42,000 +/− 1000 | 50,000 +/− 100,000 |
| 60,000 | 80,000 +/− 7,000 | 70,000 +/− 20,000 |

After reordering by Standard deviation for Model A:

| Continuous Variable Target | Model A |
|---|---|
| 30,000 | 40,000 +/− 100 |
| 45,000 | 42,000 +/− 1000 |
| 60,000 | 80,000 +/− 7,000 |

After reordering by Standard deviation for Model B:

| Continuous Variable Target | Model B |
|---|---|
| 30,000 | 30,000 +/− 50 |
| 60,000 | 70,000 +/− 20,000 |
| 45,000 | 50,000 +/− 100,000 |

Assuming that an automatically and/or manually determined fixed interval is 10,000, then it can be observed that Model B predicts within the determined interval for all predictions of the continuous variable, whereas Model 1 is outside of the interval for the third prediction of 80,000 since 80,000−7000=73,000 and 73,000 is more than 10,000 from the desired continuous variable target of 60,000. Thus, if the three exemplary predictions were plotted, Model B would follow the idealized curve 460 in FIG. 6, whereas Model A would deviate from the curve after the third prediction.

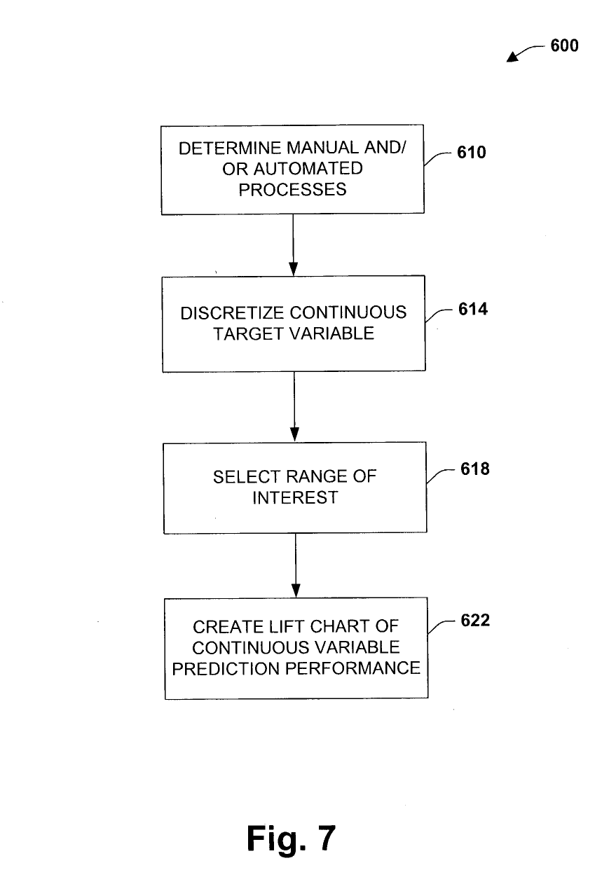

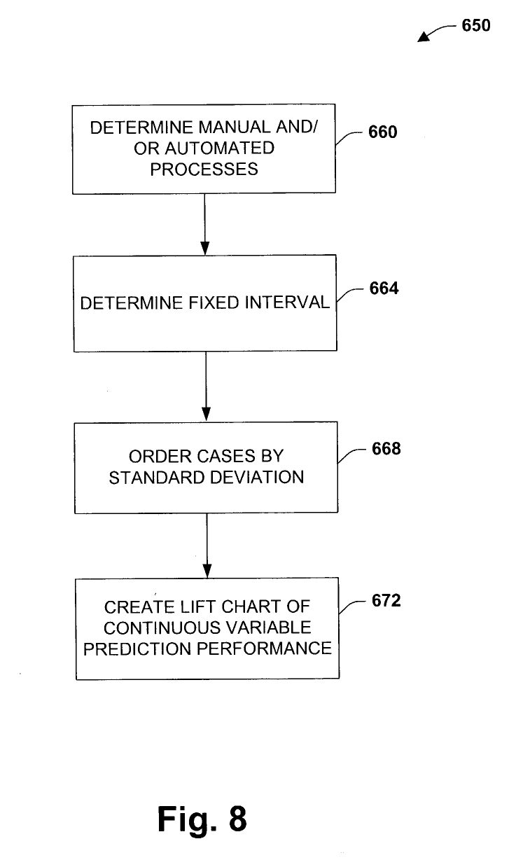

FIGS. 7 and 8 illustrate methodologies to facilitate continuous variable prediction model analysis in accordance with the present invention. While, for purposes of simplicity of explanation, the methodologies may be shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

FIG. 7 is a diagram illustrating a discretized methodology 600 to facilitate building a continuous variable lift chart in accordance with an aspect of the present invention. At 610, inputs are selected that drive manual and/or automated processes in accordance with the present invention. For example, in discrete-based methods, a continuous variable may be discretized in accordance with manual definitions of ranges, automatic range determinations, and/or combinations thereof. At 614, a continuous variable is discretized in accordance with the determinations at 610. As noted above, this can include mathematical analysis such as distribution determinations, standard deviation, mean, as well as other forms of analysis. After the continuous variable has been discretized, one or more ranges are selected for analysis and/or display. As noted above, this can include manual and/or automated selections such as “Display all predictions for continuous variable above range X”—as well as a plurality of other classifications. At 622, a continuous variable lift chart is created from the discretized continuous variable data. This can include displaying performance between various models as well as displaying one or more models versus idealized/non-idealized performance outcomes or displays.

FIG. 8 is a diagram illustrating a non-discretized methodology 650 to facilitate building a continuous variable lift chart in accordance with an aspect of the present invention. At 660, inputs are selected that drive manual and/or automated processes in accordance with the present invention. For example, a fixed analysis interval may be manually and/or automatically determined in accordance with the selected inputs. At 664, a continuous variable is analyzed in accordance with a fixed interval determination. This can include mathematical analysis such as a standard deviation, mean, as well as other forms of analysis. For example, a marketing manager may specify that continuous variable model performance should be analyzed within a +/−standard deviation of a mean for a given continuous variable prediction, whereby those predictions falling within the specified standard deviations are considered to be suitable and those predictions outside the given standard deviation are considered to be incorrect. At 668, continuous variable predictions are ordered according to the standard deviations determined above (e.g., order cases from lowest to highest STD, or highest to lowest STD). At 672, a continuous variable lift chart is created from the non-discretized continuous variable data that was ordered at 668. This can include displaying performance between various models as well as displaying one or more models versus idealized/non-idealized performance outcomes or displays.

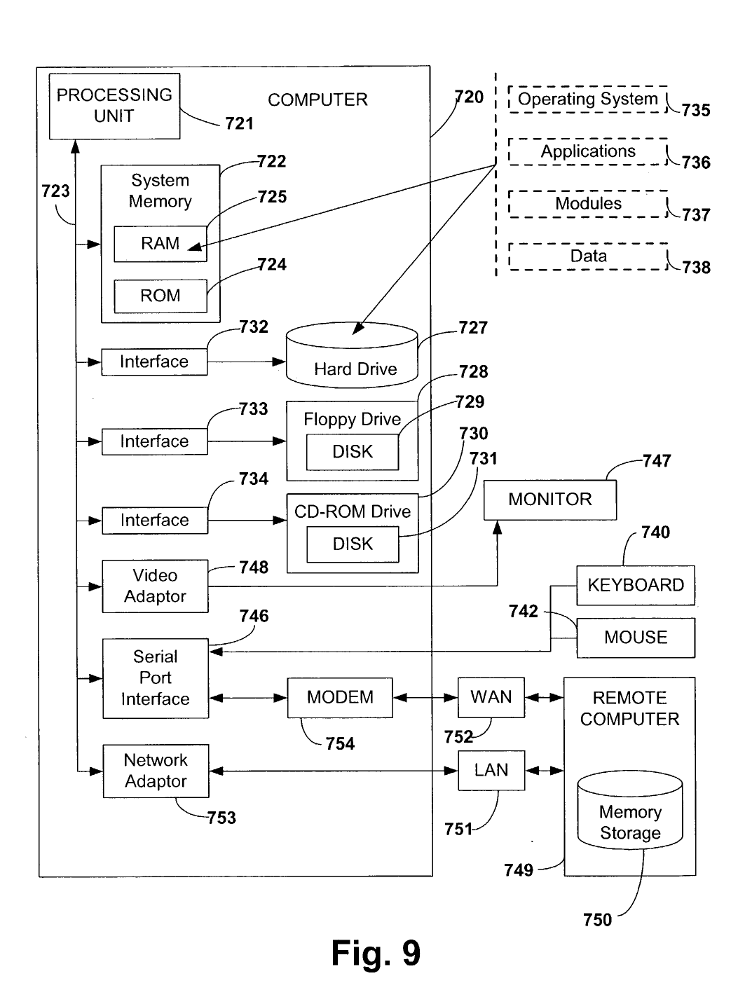

In order to provide a context for the various aspects of the invention, FIG. 9 and the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary system for implementing the various aspects of the invention includes a computer 720, including a processing unit 721, a system memory 722, and a system bus 723 that couples various system components including the system memory to the processing unit 721. The processing unit 721 may be any of various commercially available processors. It is to be appreciated that dual microprocessors and other multi-processor architectures also may be employed as the processing unit 721.

The system bus may be any of several types of bus structure including a memory bus or memory controller, a peripheral bus, and a local bus using any of a variety of commercially available bus architectures. The system memory may include read only memory (ROM) 724 and random access memory (RAM) 725. A basic input/output system (BIOS), containing the basic routines that help to transfer information between elements within the computer 720, such as during start-up, is stored in ROM 724.

The computer 720 further includes a hard disk drive 727, a magnetic disk drive 728, e.g., to read from or write to a removable disk 729, and an optical disk drive 730, e.g., for reading from or writing to a CD-ROM disk 731 or to read from or write to other optical media. The hard disk drive 727, magnetic disk drive 728, and optical disk drive 730 are connected to the system bus 723 by a hard disk drive interface 732, a magnetic disk drive interface 733, and an optical drive interface 734, respectively. The drives and their associated computer-readable media provide nonvolatile storage of data, data structures, computer-executable instructions, etc. for the computer 720. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM 725, including an operating system 735, one or more application programs 736, other program modules 737, and program data 738. It is noted that the operating system 735 in the illustrated computer may be substantially any suitable operating system.

A user may enter commands and information into the computer 720 through a keyboard 740 and a pointing device, such as a mouse 742. Other input devices (not shown) may include a microphone, a joystick, a game pad, a satellite dish, a scanner, or the like. These and other input devices are often connected to the processing unit 721 through a serial port interface 746 that is coupled to the system bus, but may be connected by other interfaces, such as a parallel port, a game port or a universal serial bus (USB). A monitor 747 or other type of display device is also connected to the system bus 723 via an interface, such as a video adapter 748. In addition to the monitor, computers typically include other peripheral output devices (not shown), such as speakers and printers.

The computer 720 may operate in a networked environment using logical connections to one or more remote computers, such as a remote computer 749. The remote computer 749 may be a workstation, a server computer, a router, a peer device or other common network node, and typically includes many or all of the elements described relative to the computer 720, although only a memory storage device 750 is illustrated in FIG. 9. The logical connections depicted in FIG. 9 may include a local area network (LAN) 751 and a wide area network (WAN) 752. Such networking environments are commonplace in offices, enterprise-wide computer networks, Intranets and the Internet.

When employed in a LAN networking environment, the computer 720 may be connected to the local network 751 through a network interface or adapter 753. When utilized in a WAN networking environment, the computer 720 generally may include a modem 754, and/or is connected to a communications server on the LAN, and/or has other means for establishing communications over the wide area network 752, such as the Internet. The modem 754, which may be internal or external, may be connected to the system bus 723 via the serial port interface 746. In a networked environment, program modules depicted relative to the computer 720, or portions thereof, may be stored in the remote memory storage device. It will be appreciated that the network connections shown are exemplary and other means of establishing a communications link between the computers may be employed.

In accordance with the practices of persons skilled in the art of computer programming, the present invention has been described with reference to acts and symbolic representations of operations that are performed by a computer, such as the computer 720, unless otherwise indicated. Such acts and operations are sometimes referred to as being computer-executed. It will be appreciated that the acts and symbolically represented operations include the manipulation by the processing unit 721 of electrical signals representing data bits which causes a resulting transformation or reduction of the electrical signal representation, and the maintenance of data bits at memory locations in the memory system (including the system memory 722, hard drive 727, floppy disks 729, and CD-ROM 731) to thereby reconfigure or otherwise alter the computer system's operation, as well as other processing of signals. The memory locations wherein such data bits are maintained are physical locations that have particular electrical, magnetic, or optical properties corresponding to the data bits.

What has been described above are preferred aspects of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A system that generates a continuous variable prediction lift chart, comprising:
an analyzer that receives data from one or more models and a continuous variable test data set; and
a formatter that generates a continuous variable lift chart based on the analyzed model data and the continuous variable test data set.

2. The system of claim 1, the analyzer discretizes the data into one or more ranges within the distribution of a continuous variable.

3. The system of claim 1, the one or more models are associated with a data mining application that generate predictions based upon one or more queries.

4. The system of claim 3, the one or more queries are based upon a Structured Query Language (SQL).

5. The system of claim 1, the lift chart depicts model performance in at least one of linear and non-linear formats, and in accordance with at least one of various colors, sounds, shapes, dimensions, axis identifiers, line formats, text descriptions, text formats, and fonts.

6. The system of claim 1, the lift chart depicts model performance as a comparison between models.

7. The system of claim 1, the lift chart depicts model performance as a comparison to at least one of an idealized model and a random model.

8. The system of claim 2, the one or more ranges are discretized via at least one of a manual indication and an automatic determination.

9. The system of claim 8, the automatic determination includes at least one of k-tiling, a mean function, and a standard deviation function.

10. The system of claim 1, the formatter utilizes at least one of a manual indication and an automatic determination to build the continuous variable lift chart.

11. The system of claim 1, the continuous variable lift chart depicts model performance versus a selected range.

12. The system of claim 1, the continuous variable lift chart depicts model performance versus a plurality of ranges.

13. The system of claim 1, the continuous variable lift chart depicts model performance as a measure of whether the model is within a determined interval of a target prediction.

14. The system of claim 13, the determined interval is at least one of manually determined and automatically determined.

15. The system of claim 13, the determined interval is a function of at least one of a mean and a standard deviation in a marginal distribution.

16. A computer-readable medium having computer-executable instructions stored thereon to perform analysis and formatting in accordance with claim 1.

17. A method for generating a continuous variable lift chart, comprising:
segmenting a continuous target variable into one or more ranges;
generating model predictions associated with the one or more ranges; and
creating a lift chart that depicts an association between the predictions and the one or more ranges.

18. The method of claim 17, further comprising providing at least one of automatic and manual inputs to segment the continuous target variable.

19. The method of claim 17, the automatic inputs further comprises processing the continuous target variable via at least one of a statistical process and a k-tiling process.

20. The method of claim 19, creating a lift chart further comprises displaying performance of a model versus at least one of a manually specified range, an automatically determined range, a plurality of manually specified ranges, and a plurality of automatically determined ranges.

21. The method of claim 17, the range further comprising at least one of:
creating a range less than a standard deviation of a mean;
creating a range between −1 and +1 of a standard deviation of the mean; and
creating a range greater than one standard deviation from the mean.

22. A method for generating a continuous variable lift chart, comprising:
defining a measurement interval for a continuous target variable;
generating model predictions associated with the continuous target variable; and
creating a lift chart that depicts an association between the predictions and the measurement interval.

23. The method of claim 22, the measurement interval is at least one of manually determined and automatically determined.

24. The method of claim 23, the measurement interval is a function of a mean and standard deviation from the actual value of the continuous target variable.

25. The method of claim 22, creating a lift chart further comprises displaying performance of a model versus at least one of a manually specified interval and an automatically determined interval.

26. A system that generates a continuous variable prediction lift chart, comprising:
means for generating prediction data from one or more continuous variable models;
means for comparing the prediction data against one or more testing parameters; and
means for generating a continuous variable lift chart based on the prediction data and the testing parameters.

27. The system of claim 26, further comprising means for displaying the lift chart.

28. The system of claim 26, further comprising means for controlling at least one of automated processes and manual processes to generate the continuous variable lift chart.

29. The system of claim 26, the testing parameters including at least one of one or more ranges and a determined measurement interval.

30. A signal to communicate lift chart data between at least two nodes, comprising:
a data packet comprising:
an analysis data component derived from continuous variable prediction data and continuous variable test data; and
a display data component reflecting a relationship between the continuous variable prediction data and the continuous variable test data.

31. A computer-readable medium having stored thereon a data structure, comprising:
a first data field containing prediction data associated with at least one continuous variable;
a second data field containing test data associated with the at least one continuous variable; and
a third data field that defines an association between the first and second data fields to facilitate display of a continuous variable lift chart.
